(19) United States
(12) Patent Application Publication
(10) Pub. No.: US 2019/0013109 A1
(43) Pub. Date: Jan. 10, 2019

(54) SWITCHABLE RADIATION SOURCE

(71) Applicants: Hyoung K. Lee, Rolla, MO (US); Kyle Paaren, Rolla, MO (US); Ayodeji B. Alajo, Rolla, MO (US)

(72) Inventors: Hyoung K. Lee, Rolla, MO (US); Kyle Paaren, Rolla, MO (US); Ayodeji B. Alajo, Rolla, MO (US)

(73) Assignee: The Curators of the University of Missouri, Columbia, MO (US)

(21) Appl. No.: 16/027,632

(22) Filed: Jul. 5, 2018

Related U.S. Application Data
(60) Provisional application No. 62/529,583, filed on Jul. 7, 2017.

(51) Int. Cl. G21G 4/02; G21G 4/08; G21H 1/04

(52) U.S. Cl. CPC G21G 4/02; G21H 1/04; G21G 4/08

(57) ABSTRACT

A switchable radiation source device includes a primary source assembly that emits primary radiation, and a target assembly in which, upon irradiation of the target assembly by the primary radiation, secondary radiation or radioactivity is produced. An alignment, proximity or exposure of the primary source assembly to the target assembly is adjustable to control irradiation of the target assembly by the primary radiation and thereby control the production of secondary radiation or radioactivity.

### CROSS-REFERENCE TO RELATED APPLICATION

This application claims the benefit of priority of U.S. provisional patent application No. 62/529,583, titled “SWITCHABLE RADIATION SOURCE,” filed on Jul. 7, 2017, which is incorporated herein in its entirety by this reference.

### TECHNICAL FIELD

The present disclosure relates to radiation or radioisotope production. More particularly, the present disclosure relates to secondary radiation or radioisotope production controlled by adjusting alignment, proximity or exposure of a primary source to a target.

### BACKGROUND

Emissions of natural radioactive isotopes occur with decay time and emitted radiation dictated by nuclear species. Many uses have been found for natural radioactive sources. Secondary radiation or radioisotopes can be produced when primary radiations by a natural source cause reactions or excited state populations in nuclei in a target. A great variety of radiation types characterized by emission type, time properties, and energy would be available if primary sources could be controllably paired with target materials.

### SUMMARY

This summary is provided to introduce in a simplified form concepts that are further described in the following detailed descriptions. This summary is not intended to identify key features or essential features of the claimed subject matter, nor is it to be construed as limiting the scope of the claimed subject matter.

According to at least one embodiment, a switchable radiation source device includes: a primary source assembly that emits primary radiation; and a target assembly in which, upon irradiation of the target assembly by the primary radiation, secondary radiation or radioactivity is produced; wherein an alignment, proximity or exposure of the primary source assembly to the target assembly is adjustable to control irradiation of the target assembly by the primary radiation and thereby control the production of secondary radiation or radioactivity.

The primary source assembly may include at least one planar source tile; the target assembly may include at least one planar target tile; and alignment of the source tile and target tile may be adjustable by movement of the source tile or target tile. In another example, proximity of the source tile and target tile is adjustable by movement of the source tile or target tile.

The primary source assembly may include a first planar array of separated multiple source tiles; the target assembly may include a second planar array of separated multiple target tiles; and alignment of the source tiles and target tiles may be adjustable by movement of at least one of the first planar array and second planar array.

The first planar array may be a rectangular array having rows in which interstitial blank cells are placed between and separate the source tiles.

The switchable radiation source may further include a shielding shell. The primary source assembly may include a shell that at least partly encloses the target assembly, and the shielding shell may be movable by rotation or translation between the primary source assembly and target assembly.

The shielding shell may be shaped as a spherical portion that at least partly encloses the target assembly, and the shielding shell may be movable by relative rotation between the primary source assembly and target assembly.

The primary source assembly may include an outer hemispherical shell. The shielding shell may include an intermediate hemispherical shell between the outer hemispherical shell and the target assembly; and the target assembly may include an at least partially spherical core concentric with the outer hemispherical shell and intermediate hemispherical shell.

The switchable radiation source may further include a shielding plate. The primary source assembly may have a planar shape. The target assembly may have a planar shape parallel to and spaced from the primary source; and the shielding plate may be movable between the primary source assembly and the target assembly to adjust exposure of the primary source assembly to the target assembly and thereby control the production of secondary radiation or radioactivity.

The primary source assembly may have a forward active side and a rear inactive side, wherein the forward active side faces the target assembly.

The target assembly may include a stable isotope and irradiation of the target assembly by the primary radiation may create a compound nucleus and the one or more neutrons.

The target assembly may include a circular arrangement of multiple target panels, and the primary source assembly may include a source panel relative to which the circular arrangement of multiple target panels is rotatable.

The multiple target panels may include different respective target materials.

The target assembly may include an annular base ring upon which the multiple target panels are mounted in the circular arrangement.

The switchable radiation source device may be operated by rotary movement of the annular base ring relative to the source panel to at least partially align a selected target panel with the source panel.

The source panel may include an alpha-emitting radioactive isotope. The primary source assembly may emit primary radiation by natural radioactive decay. The primary source assembly may include an alpha particle emitter. The secondary radiation or radioactivity may cause ejection of one or more neutrons, the energy of which may vary according to the different respective target materials.

### BRIEF DESCRIPTION OF THE DRAWINGS

The previous summary and the following detailed descriptions are to be read in view of the drawings, which illustrate particular exemplary embodiments and features as briefly described below. The summary and detailed descriptions, however, are not limited to only those embodiments and features explicitly illustrated.

FIG. 1A is a perspective view of an alpha source according to at least one embodiment.

FIG. 1B is a view of an edge of the alpha source of FIG. 1.

FIG. 1C is an enlarged view of a portion 1C as indicated in FIG. 1B of the layered active side of the alpha source of FIG. 1A.

FIG. 2A is an exploded perspective view of a switchable source device according to at least one embodiment.

FIG. 2B is a plan view along the Z-axis of the switchable source device of FIG. 2A in an off state configuration.

FIG. 3 is a plan view along the Z-axis of the switchable source device of FIG. 2A in an on state configuration.

FIG. 4A is a partially exploded perspective view representation of a switchable source device according to at least one other embodiment.

FIG. 4B is a perspective view representation of a switchable source device according to at least one other embodiment.

FIG. 5 is a side view of a switchable source device according to yet another embodiment.

FIG. 6 is a plot, for several isotopes, of the number of initial atoms in calculations with an Am-241 source (1 Ci).

FIG. 7 is a plot of the number of product atoms in the Am-241 (1 Ci, FIG. 6) calculations.

FIG. 8 is a plot of activities of produced foils in the Am-241 (1 Ci, FIG. 6) calculations.

FIG. 9 shows simulated alpha particle paths in penetrating an Au plating and ²⁷Al target

FIG. 10 is a plot of stopping power in Al as a function of particle energy.

FIG. 11 is a plot of stopping power in Au as a function of particle energy.

FIG. 12 is a plot of neutron energies for expected neutron production.

FIG. 13A is a plan view of a switchable source device according to at least one embodiment.

FIG. 13B is a perspective view of the switchable source device of FIG. 13A.

FIG. 14 is a plot, for several isotopes, of the number of initial atoms in calculations with an Am-241 source (1 Ci).

FIG. 15 is a plot of the number of product atoms in the Am-241 (1 Ci, FIG. 15) calculations.

FIG. 16 is a plot of activities of produced foils in the Am-241 (1 Ci, FIG. 15) calculations.

FIG. 17 is a plot neutron emission rate from target foils in the Am-241 (1 Ci, FIG. 15) calculations.

### DETAILED DESCRIPTIONS

These descriptions are presented with sufficient details to provide an understanding of one or more particular embodiments of broader inventive subject matters. These descriptions expound upon and exemplify particular features of those particular embodiments without limiting the inventive subject matters to the explicitly described embodiments and features. Considerations in view of these descriptions will likely give rise to additional and similar embodiments and features without departing from the scope of the inventive subject matters. Although the term “step” may be expressly used or implied relating to features of processes or methods, no implication is made of any particular order or sequence among such expressed or implied steps unless an order or sequence is explicitly stated.

Any dimensions expressed or implied in the drawings and these descriptions are provided for exemplary purposes. Thus, not all embodiments within the scope of the drawings and these descriptions are made according to such exemplary dimensions. The drawings are not made necessarily to scale. Thus, not all embodiments within the scope of the drawings and these descriptions are made according to the apparent scale of the drawings with regard to relative dimensions in the drawings. However, for each drawing, at least one embodiment is made according to the apparent relative scale of the drawing.

In at least one embodiment, Alpha-capture reactions are used in source generation applications. A reaction is produced by having an alpha emitting isotope bombard a stable isotope, creating a compound nucleus between an alpha particle and the target nucleus. The compound nucleus will be in an excited state, and emit gammas, neutrons, and or protons depending on the target material. Target materials are specifically chosen that will emit the desired type of radiation after alpha-capture; the energy of the radiation may also vary by changing the target material. The amount of each type of radiation produced depends on the energy of the alpha particle and the target material. A thin sheet of non-metallic shielding material may be used to screen or block alpha particles from hitting the target, thus acting as an attenuator or a switch for the source generator. The non-metallic material may be moved by an actuator operated by or switched according to an electric signal.

The device may be scaled to allow for different intensities of radiation. Increasing the activity of the alpha source will result in more radiation produced by the target material through alpha capture reactions.

These descriptions detail an approach to experimental validation of previous alpha-capture cross section values and comparison to the analytical values approximated by using Hauser-Feshbach calculations. These values are then compared to analytical validated cross sections found in the NON-SMOKER database, which contains statistical model results for a range of nuclei. These cross sections are dependent on the energy of the alpha particle. This energy will vary due to different alpha sources being used. The activity of the alpha source will depend on the geometry used and the alpha flux needed for irradiation. Due to the alpha-capture cross section of the target materials being energy dependent on the alpha particle, reaction rates will be calculated for each independent source. The energy of the gammas, neutrons, and protons are dependent on the energy of the alpha particle, binding energy of the stable target, and electron structure of the stable target.

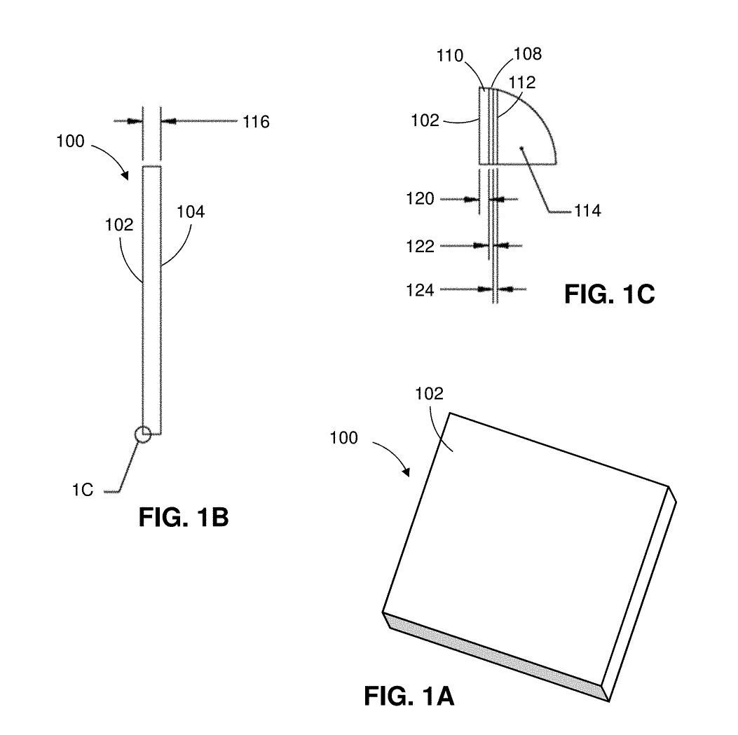

Alpha-capture cross sections for X(α,γ)Y are evaluated experimentally using multiple alpha sources and foil targets. The different alpha sources and materials are listed in Table 1. An alpha source geometry example is provided in FIG. 1. The solid angle, and nuclear forces between the alpha particle and target nucleus were considered in calculations. Experimentally measured cross sections will then be compared to NON-SMOKER database and analytically calculated values. Analytical alpha-capture cross sections were estimated using Equation 1. Variables used in Equation 1 are found in the Nomenclature Listing below and were calculated using equations from J. M. Blatt, Theoretical Nuclear Physics, New York: Springer-Verlag, 1979.

Within Equation 1, compound nucleus values are used to analytically obtain the capture cross section. The summation occurs over the angular momentum values of the alpha particle, ranging from zero to n, which is the maximum angular momentum quantum number. The change in angular momentum, denoted as Δ1, of the alpha particle from the ground state. The intrinsic spin of the alpha particle, denoted by s₁, interacting with the target nucleus as the angular momentum changes through the summation, which is constant. The wavelength of the alpha particle is λ. The wave number just after the alpha particle enters the target nucleus is K. The compound nucleus radius of the alpha particle and the target is R. R and K remain constant throughout the summation. Equation 1 is generally true for any target atom, but has been used specifically for finding alpha-capture cross sections.

The alpha-capture cross section obtained from NON-SMOKER database was used as the microscopic capture cross section in Equation 2 to determine the expected activation of the foil targets. The flux used in Equation 2 varies depending on the activity of the alpha sources. The decay constant in Equation 2 is the decay constant of the newly formed compound nucleus after alpha capture, and t is the activation time. Equation 2 was integrated over time to determine the expected counts from alpha-activation. Using an activation time of 24 hours, the integral of Equation 2 predicts the number of counts emitted from the reaction.

$$\begin{matrix}{σ}_{C} ( α ) = π {λ}^{2} {\sum }_{l = 0}^{n} ( 2 l + 1 ) \frac{4 {s}_{l} KR}{{( Δ l )}^{2} + {( KR + {s}_{l} )}^{2}} & ( Equation 1 ) \\ {A}_{t} = \frac{{amN}_{a}}{AW} {σ}_{c} φ ( 1 - {e}^{- Λ t} ) & ( Equation 2 )\end{matrix}$$

Experimental Cross Sections and Theoretical Yields of Target Materials:

Analytical validation has been done and cross sections have been obtained from the NON-SMOKER database. Values for cross sections for multiple proposed foil target materials were found (see Appendix 1 of U.S. Provisional Patent Application 62/529,583).

Alpha Sources and Target Materials:

Multiple isotopes for the alpha source may be implemented based upon the desired emission rates of different particles. The nuclear properties of the alpha sources are listed in Table 1. Alpha particle energies and their half-lives are included in Table 1.

TABLE 1
Alpha source properties

| | Alpha Energy | Half-life |
|---|---|---|
| Alpha | (Mev) | (years) |
| ¹⁴⁸Gd | 3.182 | 71.1 |
| ²¹⁰Po | 5.3044 | 0.379112329 |
| ²²⁶Ra | 4.7844 | 1600 |
| ²²⁸Th | 5.423 | 1.9116 |
| ²²⁹Th | 4.5845 | 7880 |
| ²³¹Pa | 5.013 | 32760 |
| ²³²U | 5.3203 | 68.9 |
| ²³⁶Pu | 5.7675 | 2.858 |
| ²³⁹Pu | 5.156 | 24110 |
| ²⁴⁰Pu | 5.1685 | 6561 |
| ²⁴¹Am | 5.4857 | 432.6 |
| ²⁴³Am | 5.276 | 7364 |
| ²⁴²Cm | 6.1127 | 0.446027397 |
| ²⁴³Cm | 5.785 | 29.1 |
| ²⁴⁴Cm | 5.8048 | 18.1 |
| ²⁴⁵Cm | 5.362 | 8423 |
| ²⁴⁶Cm | 5.386 | 4706 |
| ²⁴⁷Cm | 4.87 | 15600000 |
| ²⁴⁸Cm | 5.078 | 348000 |
| ²⁴⁹Cf | 5.813 | 351 |
| ²⁵⁰Cf | 6.0304 | 13.08 |
| ²⁵⁴Es | 6.429 | 0.755342466 |

Target materials were chosen specifically for their transmutation products after absorbing an alpha particle. Equation 3 demonstrates an X(α,γ)W reaction, Equation 4 demonstrates an X(a,n)W reaction, and Equation 5 demonstrates an X(a,p)W reaction. Table 2 lists the Initial material and the products produced. Table 3 and Table 4 contain nuclear properties of the target materials and the corresponding products.

α+_{y}^{z}X→_{y+2}^{z+4}W+γ (Equation 3)

α+_{y}^{z}X→_{y+2}^{z+3}W+n (Equation 4)

α+_{y}^{z}X→_{y+1}^{z+3}W+p (Equation 5)

In Equation 3, a is the alpha particle, y is the atomic number of the target material, z is the atomic mass of the target material, and γ is the photon emission from the reaction. X is the target material and W is the product of X after transmutation.

TABLE 2
Target materials and corresponding products

| Target | | Product | Product |
|---|---|---|---|
| (X) | Product (α, γ) | (α, n) | (α, p) |
| ³⁹K | ⁴³Sc | ⁴²Sc | ⁴²Ca |
| ⁴⁰K | ⁴⁴Sc | ⁴³Sc | ⁴³Ca |
| ⁴⁰Ca | ⁴⁴Ti | ⁴³Ti | ⁴³Sc |
| ⁴⁷Ti | ⁵¹Cr | ⁵⁰Cr | ⁵⁰V |
| ⁵⁸Ni | ⁶²Zn | ⁶¹Zn | ⁶¹Cu |
| ⁶³Cu | ⁶⁷Ga | ⁶⁶Ga | ⁶⁶Zn |
| ⁷⁹Br | ⁸³Rb | ⁸²Rb | ⁸²Kr |
| ⁴⁸Ca | ⁵²Ti | ⁵¹Ti | ⁵¹Sc |

TABLE 3
Target material properties

| Target | | atomic |
|---|---|---|
| (X) | abundance | weight |
| ³⁹K | 0.932581 | 38.96370649 |
| ⁴⁰K | 0.9 | 39.96399817 |
| ⁴⁰Ca | 0.96941 | 39.9626 |
| ⁴⁷Ti | 0.0744 | 46.95175879 |
| ⁵⁸Ni | 0.680769 | 57.93534241 |
| ⁶³Cu | 0.6915 | 62.92959772 |
| ⁷⁹Br | 0.5069 | 78.91833758 |
| ⁴⁸Ca | 0.00187 | 47.95252277 |

TABLE 4
Product nuclear properties

| | | Decay Constant | gamma energy | emission |
|---|---|---|---|---|
| Product (W) | Half-life (s) | (s⁻¹) | (Mev) | rate |
| ⁴²Sc | 0.6813 | 1.02E+00 | 1524 | 0.000075 |
| ⁴³Sc | 14007.6 | 4.95E−05 | 372.9 | 0.225 |
| ⁴⁴Sc | 14292 | 4.85E−05 | 1157 | 0.999 |
| ⁵¹Sc | 12.4 | 5.59E−02 | 1437.3 | 0.52 |
| ⁴²Ca | stable | 0 | N/A | N/A |
| ⁴³Ca | stable | 0 | N/A | N/A |
| ⁴⁴Ti | 1.87E+09 | 3.71E−10 | 78.3 | 0.964 |
| ⁵¹Ti | 345.6 | 2.01E−03 | 320.076 | 0.93 |
| ⁵²Ti | 102 | 6.80E−03 | 124.45 | 0.917 |
| ⁵³Ti | 0.509 | 1.36E+00 | 2288 | 0.044 |
| ⁵⁰V | stable | 0 | N/A | N/A |
| ⁵⁰Cr | stable | 0 | N/A | N/A |
| ⁵¹Cr | 2.39E+06 | 2.90E−07 | 320 | 0.09 |
| ⁶¹Cu | 12020.4 | 5.77E−05 | 282.956 | 0.122 |
| ⁶¹Zn | 89.1 | 7.78E−03 | 475 | 0.165 |
| ⁶²Zn | 33192 | 2.09E−05 | 596 | 0.26 |
| ⁶⁶Zn | stable | 0 | N/A | N/A |
| ⁶⁶Ga | 34164 | 2.03E−05 | 1039 | 0.37 |
| ⁶⁷Ga | 281759.04 | 2.46E−06 | 93, 184, 300 | 0.38 |
| ⁸²Kr | stable | 0 | N/A | N/A |
| ⁸²Rb | 75.45 | 9.19E−03 | 776.5 | 0.1508 |
| ⁸³Rb | 7.45E+06 | 9.31E−08 | 520 | 0.45 |

Device Geometry:

A switchable radioisotope source device can utilize alpha particles to irradiate stable target materials to emit photons, neutrons, and or protons. Depending on the need of the consumer and the application, the size and strength of the switchable isotope source device may be changed. The probability of producing each particle and product may be found in the preceding under Experimental Cross Sections and Theoretical Yields of Target Materials and in Appendix 1 of U.S. Provisional Patent Application 62/529,583, and are dependent on the alpha particle energy. Specific activities of the produced products may be between 1000 and 10000 Bq/g.

FIG. 1A is a perspective view of a layered alpha source assembly 100 according to at least one embodiment. FIG. 1B is a view of an edge of the alpha source of FIG. 1. The alpha source assembly 100 is shown as a panel or generally planar construction having a forward active side 102 and a rear inactive side 104. The relative and absolute outer dimensions of the alpha source assembly 100 such as length and width can be selected according to use. A square tile geometry is illustrated as one example. Other shapes are within the scope of these descriptions. For example, triangular, hexagonal, and other shapes may be used.

As shown in FIG. 1C, the illustrated layered alpha source assembly 100 has an active matrix 108 between a forward layer 110 and an interface layer 112. This forward laminate assembly, including the forward layer 110, active matrix 108, and interface layer 112 is mounted on a rearward backing 114. The forward layer 110 may be or include Au or Palladium for example. The interface layer 112 may be or include Au for example. The rearward backing 114 may be or include Ag for example.

In at least one example according to FIGS. 1A-1C: the total thickness 116 of the layered alpha source assembly 100 is in a range of approximately 0.15 millimeters to 0.25 millimeters; the thickness 120 of the forward layer 110 is approximately 0.002 millimeter; the thickness 122 of the active matrix 108 is approximately 0.002 millimeter; the thickness 124 of the interface layer 112 is approximately 0.001 millimeter; and the thickness of the backing 114 accounts for the remainder of the total thickness 116. All materials and dimensions are provided as non-limiting examples.

Switchable Source Device:

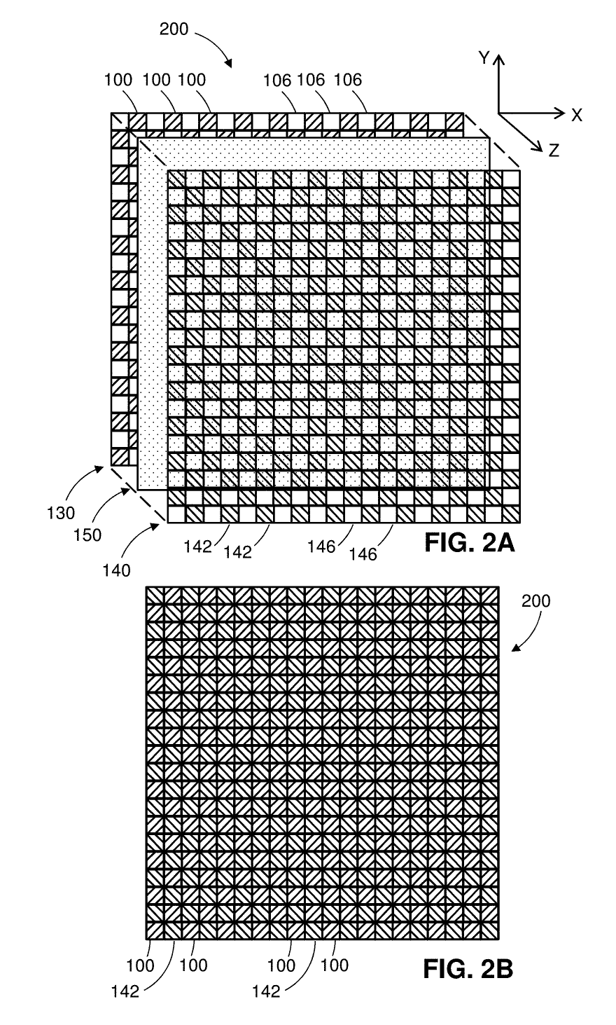

FIG. 2A is an exploded perspective view of a switchable source device 200 according to at least one embodiment. The device 200 includes a rearward patterned source panel 130 that includes source assemblies 100 (see FIG. 1) serving as tiles, represented as patterned cells, in a checkered arrangement extending along X and Y axis directions. In the source panel 130, intermediate inactive spaces or tiles 106, represented as interstitial blank cells, are placed between the separated source assemblies 100. The device 200 includes a forward patterned target panel 140 that includes target tiles 142, represented as patterned cells, separated by unreactive spaces or tiles 146, represented as blank cells. Z-axis spacing of the source panel 130 and target panel 140 may be exaggerated in the drawings to illustrate the layered construction of the switchable source device 200. Dimensions are not necessarily represented to scale. An optional shielding panel 150 is shown in FIG. 2A as positioned between the source panel 130 and target panel 140.

In FIG. 2A, the forward active sides 102 (FIG. 1) of the source assemblies 100 of the patterned source panel 130 face forward toward the target panel 140. The configuration of the switchable source device 200 in FIG. 2A represents an off state of the device 200 with regard to secondary radiation or radioactivity production due to both the position of the intervening shielding panel 150 and the alignment (X-Y) of the source assemblies or tiles 100 with the unreactive spaces or tiles 146 of the target panel 140.

FIG. 2B is a plan view along the Z-axis of the source panel 130 and target panel 140, with the shielding panel 150 either removed or shown as transparent to illustrate the offset or misaligned X-Y positions of the source assembly or tiles 100 with the target tiles 142 of the target panel 140. Thus, in FIG. 2B, primary radiations emitted by the source panel 130 only minimally or peripherally reach the target tiles 142 in the off state of the device 200 and so secondary radiation or radioactivity production is minimized. Primary radiations refer to source or origin radiations at the source panel, and include for example natural radioactive decay. Secondary radiation production refers to induced, produced or otherwise resultant radiation, radioactivity, or radioisotopes that occur as the primary radiations cause reactions or excited state populations in nuclei at the target panel.

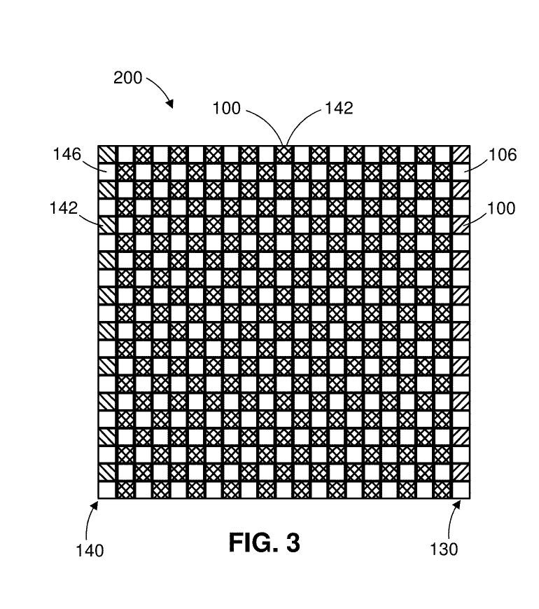

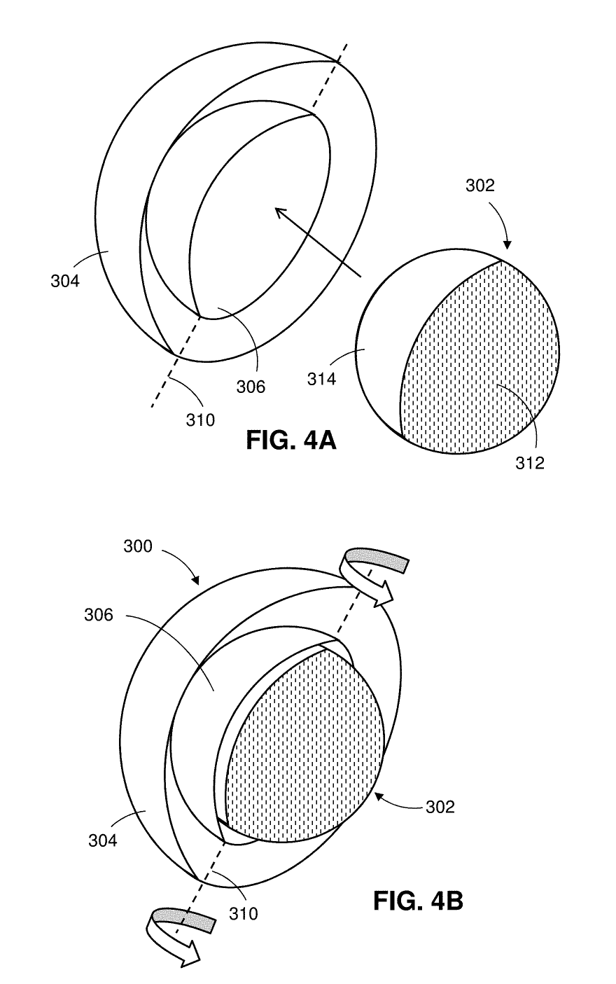

FIG. 3 is a plan view along the Z-axis of the source panel 130 and target panel 140, with the shielding panel 150 either removed or shown as transparent to illustrate aligned X-Y positions of the source assembly 100 tiles with the target tiles 142 of the target panel 140. In particular, the target panel 140 in FIG. 3 is shifted along the X-axis by one cell relative to FIG. 1. The shift brings the X-Y positions of many of the source tiles into alignment with the target tiles as represented by the superimposed cell patterns at coinciding X-Y positions. Thus, in FIG. 3, primary radiations emitted by the source panel 130 optimally and maximally reach the target tiles 142 and so secondary radiation or radioactivity production is maximized. This configuration represents an on state of the switchable source device 200.

While a square tile geometry is illustrated, other shapes that overlap into alignment and stagger out of alignment are within the scope of these descriptions. For example, other rectangular shapes other than squares may be used, and triangular, hexagonal, and other shapes may be used.

In FIGS. 2A, 2B and 3, the checkered pattern allows for the target material to slide over the source material, enabling secondary radiation to be turned on and off. This checkered pattern may be implemented twice to create a solid panel. This concept can also be applied to a single plate and a single target. This geometry may be very small around 1 cm for material identification or as large as several meters for gamma ray or neutron imaging for large scale transportation.

Spherical source:

FIG. 4A is a partially exploded perspective view representation of a switchable source device 300 according to at least one other embodiment. The switchable source device 300 is shown assembled in perspective view in FIG. 4B. The switchable source device 300 includes an inner spherical target core 302, an outer source shell 304, and a radially intermediate shielding shell 306. The core 302, source shell 304 and intermediate shielding shell 306 are concentric (FIG. 4B) in the assembled device 300. Each has a full spherical, hemispherical, or partial spherical shape in various embodiments. In the illustrated embodiment, the target core 302 has a spherical form with a first hemisphere 312 (FIG. 4A) that includes a first target material and an opposite second hemisphere 314 that includes a second material, which may be a different target material than the first or may be inert.

In the particularly illustrated design of FIG. 4, the shielding hemisphere 306 rotates around the diametric axis 310, which allows source-target interactions and consequent produced secondary radiations to be turned on and off. The spherical geometry allows for a higher alpha particle flux on the target material and increases emissions, relative to other geometries such as planar examples, by changing the surface area/volume ratio of the target. The size of the spherical design is meant to be within centimeters in at least one embodiment. The material of the shielding shell 306 can be a material that is immune to alpha capture due to the Coulomb force in the nucleus. Non-limiting example materials are gold, tungsten, and rhenium. Containment of the alpha particles is not a concern as they contribute no external dose, but the produced gammas may be collimated to direct the isotropic source.

Plate with shielding:

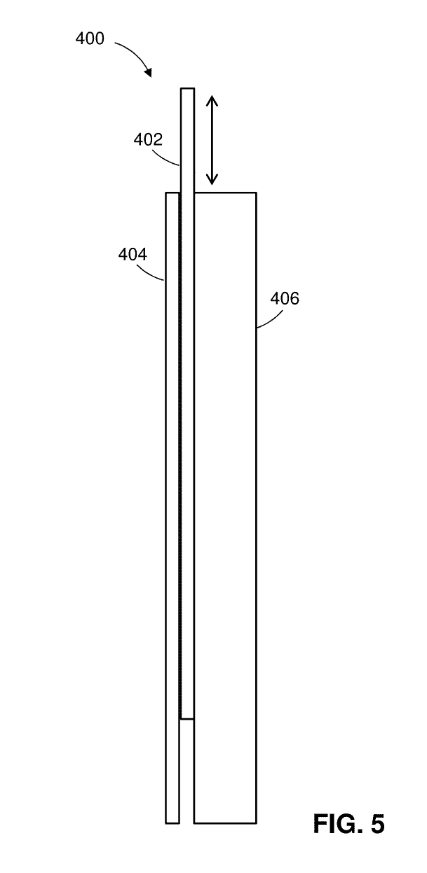

FIG. 5 is a side view of a switchable source device 400 according to yet another embodiment. Produced secondary radiation is controlled by a movable shielding plate 402 between a source panel 404 and a target material panel 406. The shielding may be lowered completely to stop all interactions. The side view of FIG. 5 is shown to better illustrate the geometry since the plates are very long and thin. This geometry may be very small around 1 cm for material identification or as large as several meters for gamma ray or neutron imaging for large scale transportation. The shielding material will be a material that is immune to alpha capture due to the Coulomb force in the nucleus. Such materials include for example gold, tungsten, and rhenium. Containment of the alpha particles is not a concern as they contribute no external dose, but the produced gammas may be collimated to direct the isotropic source.

Expected Activities and Products:

The activities of activated foils were calculated using Mathcad 15 by utilizing coupled differential equations. The alpha-capture cross sections for each of the foil materials were interpolated for an energy of 5.48 MeV. Activities of activated foils were calculated for 1 Ci, 0.1 Ci, and 10 mCi sources of ²⁴¹Am. Based on the results, the activated material for spectroscopy is obtained using a 1 Ci ²⁴¹Am on nickel and copper foil targets. Potassium was disregarded due to it being a very reactive metal. These calculations are to show proof of concept for the switchable radioisotope and are to be used as a template to calculate product activities.

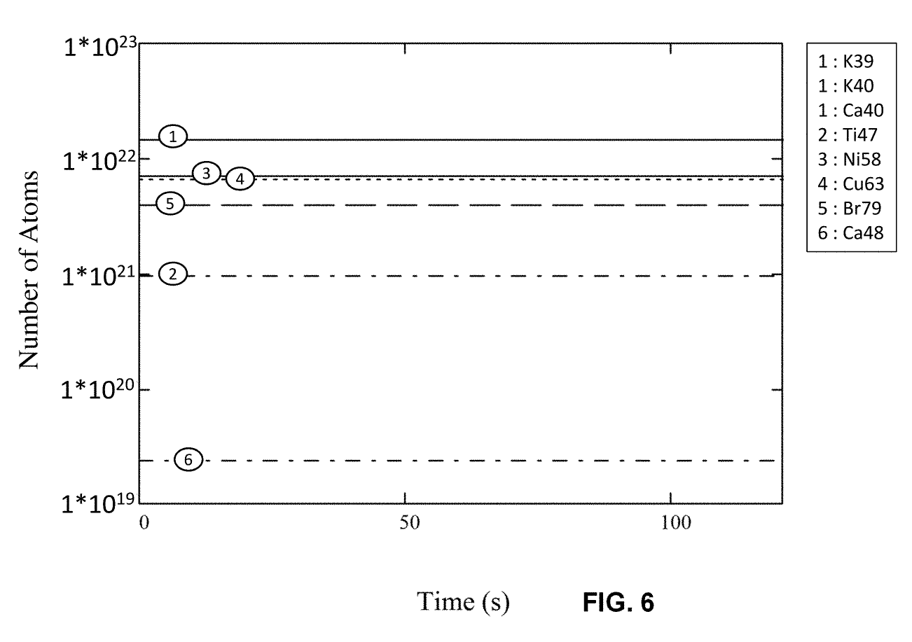

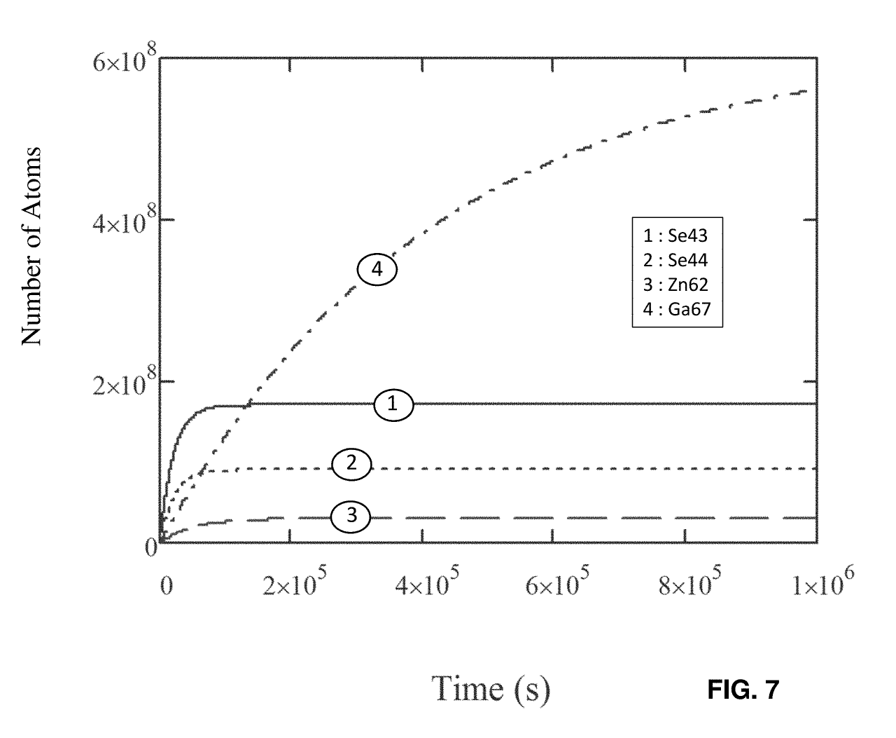

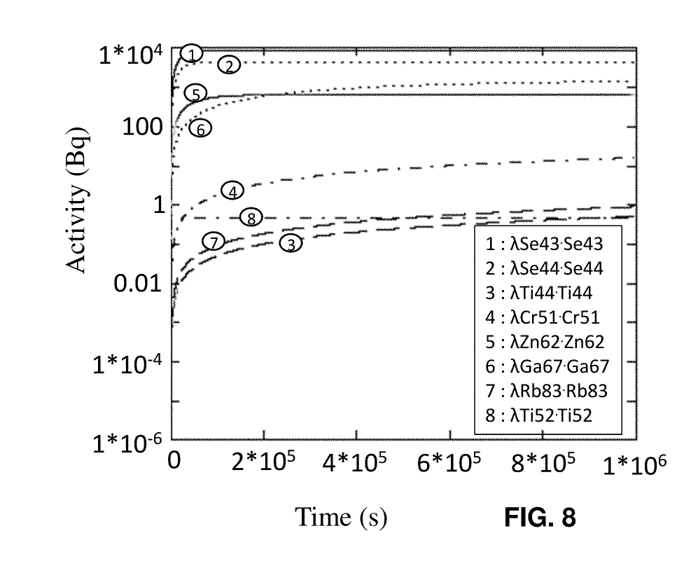

FIG. 6 is a plot, for several isotopes, of the number of initial atoms in calculations with an Am-241 source (1 Ci). FIG. 7 is a plot of the number of product atoms in the Am-241 (1 Ci, FIG. 6) calculations. FIG. 8: is a plot of activities of produced foils in the Am-241 (1 Ci, FIG. 6) calculations.

Similar calculations as those for which the results are shown in FIG. 6-8 (1 Ci Am-241) were performed for a 0.1 Ci ²⁴¹Am source. This reduced the order of magnitude of the activity and flux by one. Similar calculations were also performed for the 10 mCi ²⁴¹Am source. This further reduced the order of magnitude of the activity and flux by one relative to the 0.1 Ci calculations, demonstrating the results varied to scale with source activity. All cross sections and decays were kept the same.

Nomenclature Listing:

a=isotope abundance

Aₜ=activity

AW=atomic weight

Δl=angular momentum change

Λ=decay constant

λ=alpha particle wavelength

K=Wave number inside target nuclear surface

l=angular momentum of alpha particle

m=mass

n=maximum angular momentum of alpha particle

Nₐ=Avogadro's number

R=compound nuclear radius

sₗ=intrinsic spin of alpha particle

Φ=flux

A reaction in the above or other embodiments as described below is produced by having an alpha emitting isotope bombard a stable isotope, creating a compound nucleus and the ejection of a neutron. Radiations such as gammas and or neutrons are then emitted depending on the target material. Target materials are specifically chosen that will emit the desired type of neutron energy after alpha-capture; the scattering angle of the radiation may also vary by changing the target material. The amount of each type of radiation produced depends on the energy of the alpha particle and the target material. A rotary device may be used to place targets in front of or away from alpha particles, thus acting as a switch for the neutron source generator. The rotary device may be moved through an electric signal or mechanically.

Alpha-capture cross sections for ²⁷Al(α,n)³⁰P are evaluated experimentally using a 90 μCi ²⁴¹Am alpha source and foil targets. The ²⁴¹Am alpha source information is provided in FIGS. 1A-1C. A ³He neutron detector is used to measure (α,n) reactions. The solid angle, detector efficiency, and nuclear forces between the alpha particle and target nucleus were considered in calculations. Experimentally measured cross sections will then be compared to NON-SMOKER database, ENDF, and analytically calculated values.

Cross sections found within ENDF were integrated over energy, then averaged to find the average interaction rate for each material depending on the starting energy of the alpha particle. This may be seen in Equation 6. The averaged cross section obtained from Equation 6 was used as the microscopic capture cross section in Equation 7 to determine the expected activation of the foil targets. The flux used in Equation 7 varies depending on the activity of the ²⁴¹Am source. The decay constant in Equation 7 is the decay constant of the newly formed compound nucleus after alpha capture, and t is the activation time. Equation 7 was integrated over time to determine the expected counts from alpha-activation. Using an activation time of 24 hours, the integral of Equation 7 predicts the number of counts incident on the NaI detector. Equation 8 is used to determine the neutron production rate from the foil and the expected count rate on the ³He neutron detector.

$$\begin{matrix}{σ}_{ave} = \frac{1}{{E}_{α}} {\int }_{0}^{{E}_{α}} σ ( E ) dE & ( Equation 6 ) \\ {A}_{t} = \frac{{amN}_{a}}{AW} {σ}_{ave} φ ( 1 - {e}^{- Λ t} ) & ( Equation 7 ) \\ {A}_{n} = N {σ}_{ave} φ & ( Equation 8 )\end{matrix}$$

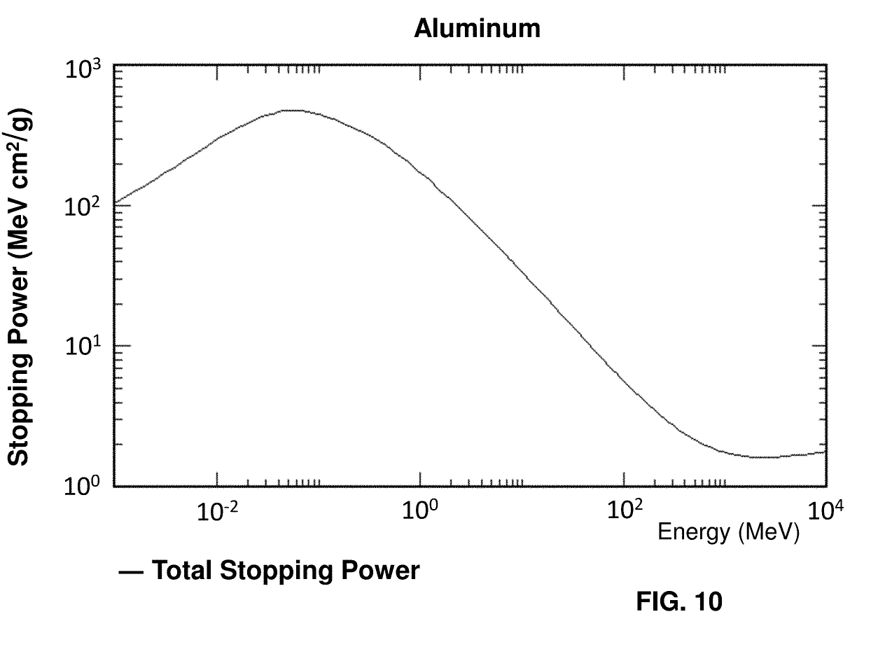

Stopping power charts for each target material was used in combination with Srim & Trim to find the range of alpha particles in various target materials. This allowed the optimal target thickness to be determined. An example of a stopping power chart is provided in FIG. 10.

Expected Neutron Production:

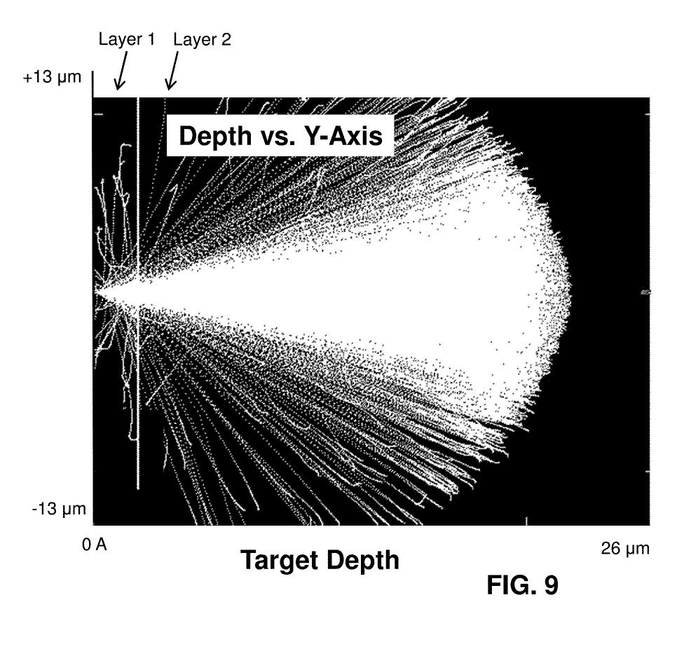

Calculating the neutron production rate for a foil target included the change in alpha energy as it moves through the foil target, secondary energy of the neutrons, angle of scattering, and energy dependent cross sections. Stopping power was used to determine the target thickness for the highest production rate. Simulations in SRIM were run to show the path alpha particles travel as they enter a ²⁷Al target, as seen in FIG. 9. This was done to show an example of the process conducted for all foil targets.

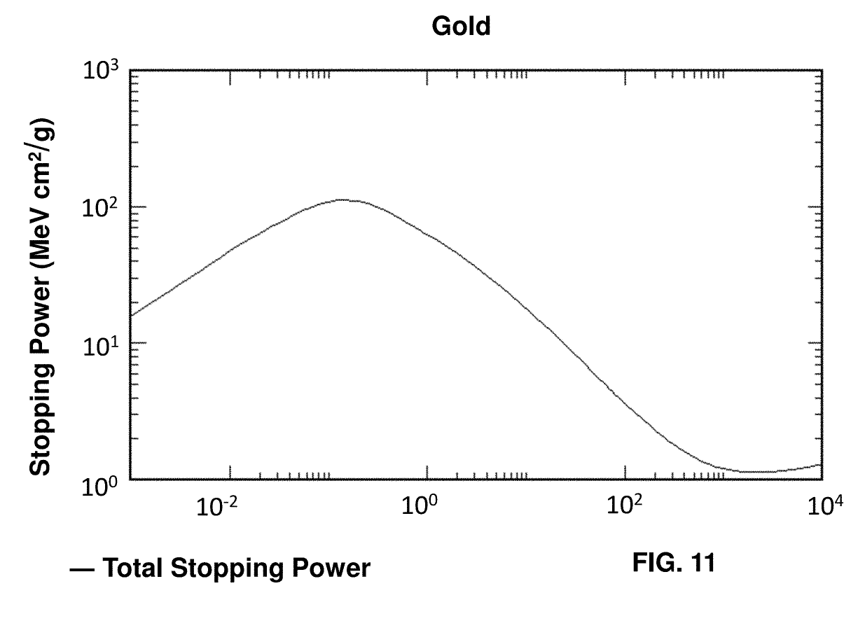

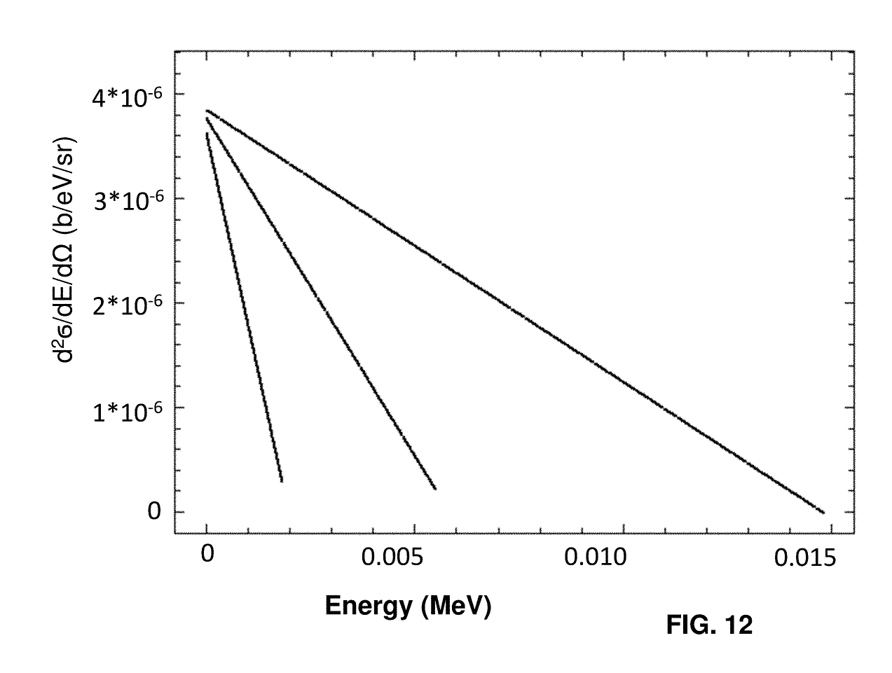

For the simulation, one hundred thousand individual particles were run. Values for ²⁷Al were integrated and averaged to account for the change in energy of the alpha particle as it moves through the ²⁷Al target. Stopping power figures shown in FIGS. 10 and 11 were used to determine the optimal target thickness, which is 25 μm. This was used to find the total number of target atoms for ²⁷Al in a 2 cm×2 cm×25 μm target foil. The number of target atoms was then multiplied by the energy averaged cross section and the alpha flux from the 90 μCi ²⁴¹Am source. This yields an expected neutron production rate of 5.6 neutrons per second, where the neutron energies may be found in FIG. 12.

Experimental Cross Sections and Theoretical Yields:

Analytical validation has been done and cross sections have been obtained from the ENDF database. Values for cross sections for the proposed foil targets were determined. The cross sections were integrated then averaged to find expected interaction rates used in calculations.

Alpha Sources and Target Materials:

Multiple isotopes for the alpha source may be implemented based upon the desired emission rates of neutrons and their respective energy. The nuclear properties of the alpha sources are listed in Table 1 in the preceding. Alpha particle energies and their half-lives are included in the table.

Target materials were chosen specifically for their transmutation products after absorbing an alpha particle. Equation 9 demonstrates an X(α,n)W reaction. Table 5 lists the initial material, the products produced, and the kinetic energy and scattering angle of the produced products. Table 6 and Table 7 contain nuclear properties of the target materials and the corresponding products.

α+_{y}^{z}X_{y+2}^{z+3}W+n (Equation 9)

In Equation 9, a is the alpha particle, y is the atomic number of the target material, z is the atomic mass of the target material, and n is the neutron emission from the reaction. X is the target material and W is the product of X after transmutation.

TABLE 5
Target materials and corresponding products

| Target | Product |
|---|---|
| (X) | (α, n) |
| ⁹Be | ¹²C |
| ¹⁰Be | ¹³C |
| ¹⁹F | ²²Na |
| ²²Ne | ²⁵Mg |
| ²³Na | ²⁶Al |
| ²⁵Mg | ²⁸Si |
| ²⁷Al | ³⁰P |
| ²⁹Si | ³²S |
| ⁴¹K | ⁴⁴Sc |
| ⁴⁵Sc | ⁴⁸V |
| ⁴⁸Ti | ⁵¹Cr |
| ⁵¹V | ⁵⁴Mn |

TABLE 6
Target material properties

| Target | | |
|---|---|---|
| (X) | abundance | atomic weight |
| ⁹Be | 1 | 9.01218207 |
| ¹⁰Be | N/A | 10.01353469 |
| ¹⁹F | 1 | 18.9984031629 |
| ²²Ne | 0.0925 | 21.991385109 |
| ²³Na | 1 | 22.989769282 |
| ²⁵Mg | 0.1 | 24.98583696 |
| ²⁷Al | 1 | 26.98153841 |
| ²⁹Si | 0.04685 | 28.9764946652 |
| ⁴¹K | 0.067302 | 40.961825258 |
| ⁴⁵Sc | 1 | 44.9559075 |
| ⁴⁸Ti | 0.7372 | 47.94794093 |
| ⁵¹V | 0.9975 | 50.9439569 |

TABLE 7
Product nuclear properties

| | | | gamma energy | emission |
|---|---|---|---|---|
| Product (W) | Half-life (s) | Decay (s) | (Mev) | rate |
| ¹²C | Stable | 0 | N/A | N/A |
| ¹³C | Stable | 0 | N/A | N/A |
| ²²Na | 82050365 | 8.45E−09 | 1274 | 0.9994 |
| ²⁵Mg | Stable | 0 | N/A | N/A |
| ²⁶Al | 2.26E+13 | 3.07E−14 | 1808 | 0.9976 |
| ²⁸Si | Stable | 0 | N/A | N/A |
| ³⁰P | 149.9 | 4.62E−03 | 2235 | 0.00059 |
| ³²S | Stable | 0 | N/A | N/A |
| ⁴⁴Sc | 14292 | 4.85E−05 | 1157 | 0.999 |
| ⁴⁸V | 1.38E+06 | 5.02E−07 | 983.5 | 0.9998 |
| ⁵¹Cr | 2.39E+06 | 2.90E−07 | 320 | 0.0919 |
| ⁵⁴Mn | 2.70E+07 | 2.57E−08 | 834.8 | 0.9998 |

Device Geometry:

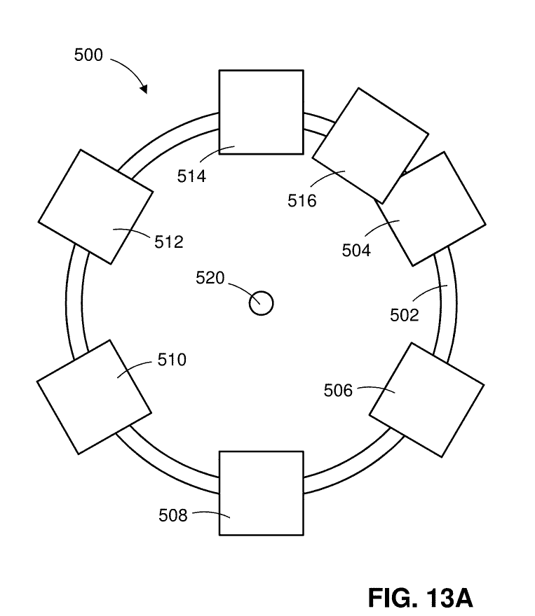

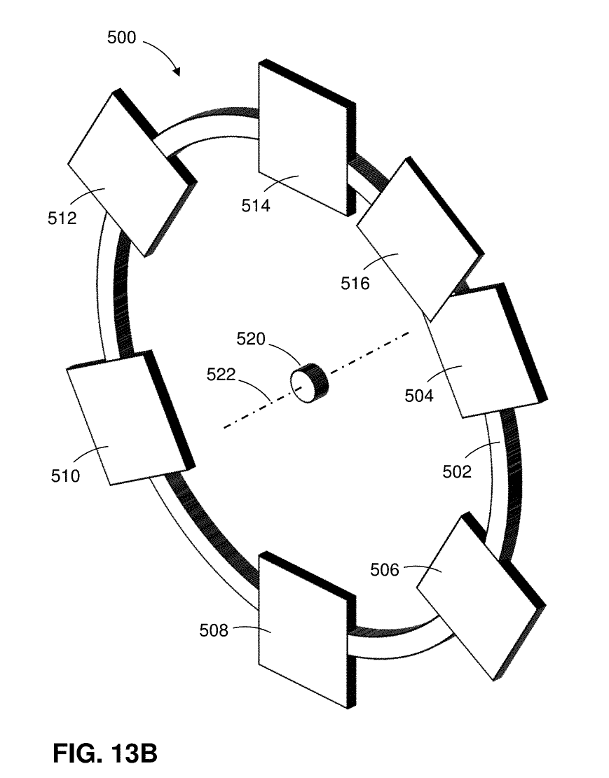

Above descriptions of particular embodiments of switchable source devices and the corresponding drawings are to be taken as cumulative with further embodiments. For example, a rotary switchable source device 500 according to at least one other embodiment is shown in FIGS. 13A and 13B. The device 500 includes an annular base ring 502 on which multiple target panels 504-514 are mounted in a circular arrangement. The base 502 may be annular as illustrated or may be otherwise circular or just rotatable relative to the arrangement of target panels. The target panels 504-514 may include different respective target materials. In the illustrated embodiment, a single source panel 516 that can be selectively aligned with any one of the target panels 504-514. The source panel 516 may for example be constructed as the source assembly 100 (see FIG. 1).

In FIGS. 13A-13B, primary radiations emitted by the source panel 516 can reach a selected target panel 504-514, where secondary radiation or radioactivity can be produced, according to alignment with the selected target panel. The rotary switchable source device 500 is operated by rotary movement of the target panels 504-514 relative to the source panel 516. Once a target panel is partially or fully aligned with the source panel 516, source-target interactions occur and consequent secondary radiations are produced. Thus, the rotary switchable source device 500 can be turned on and off by placing the source panel 516 in full-alignment and out-of-alignment positions relative to a selected target panel. The secondary radiation production rate or intensity can be controlled via partial alignment.

The rotary device 500 will allow for multiple neutron energies and fluxes depending on the target materials. The neutron flux generated by the target materials may be changed by changing the size and thickness of the targets, increasing the distance between the source and the target materials, and the strength of the source. The geometry of the rotary device and the materials may vary in size depending on the application.

Expected Activities and Products:

The activities of activated foils were calculated using Mathcad 15 by utilizing coupled differential equations. The alpha-capture cross sections for each of the foil materials were interpolated for an energy of 5.48 MeV. Activities of activated foils and neutron production rates were calculated for 1 Ci, 0.1 Ci, and 10 mCi sources of ²⁴¹Am. Each foil had a mass of 1 g.

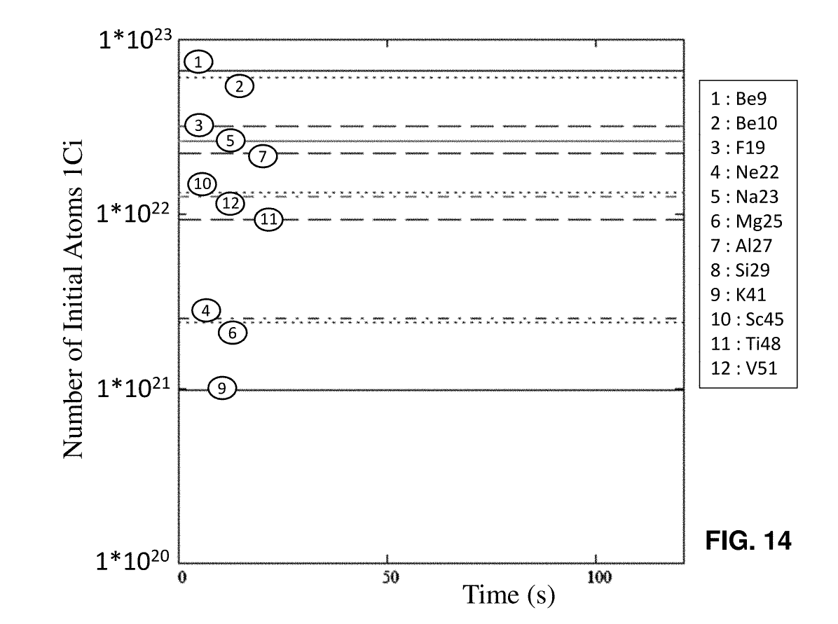

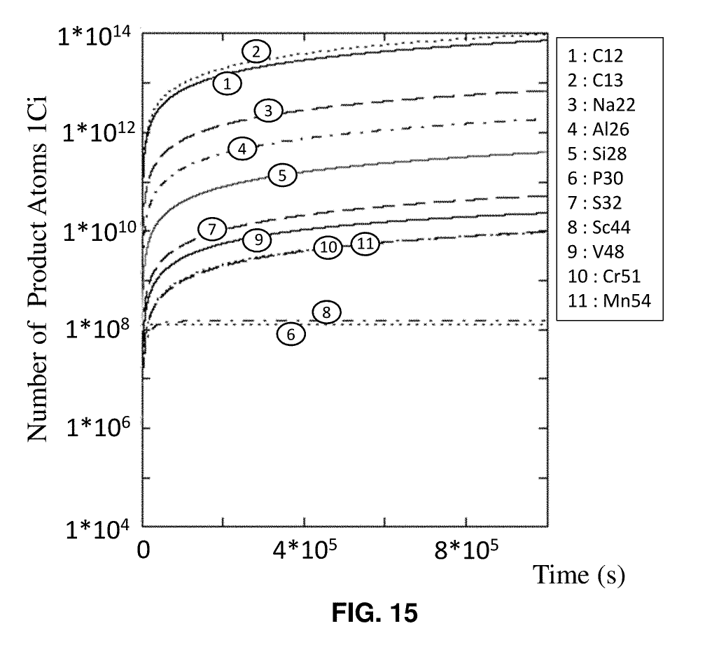

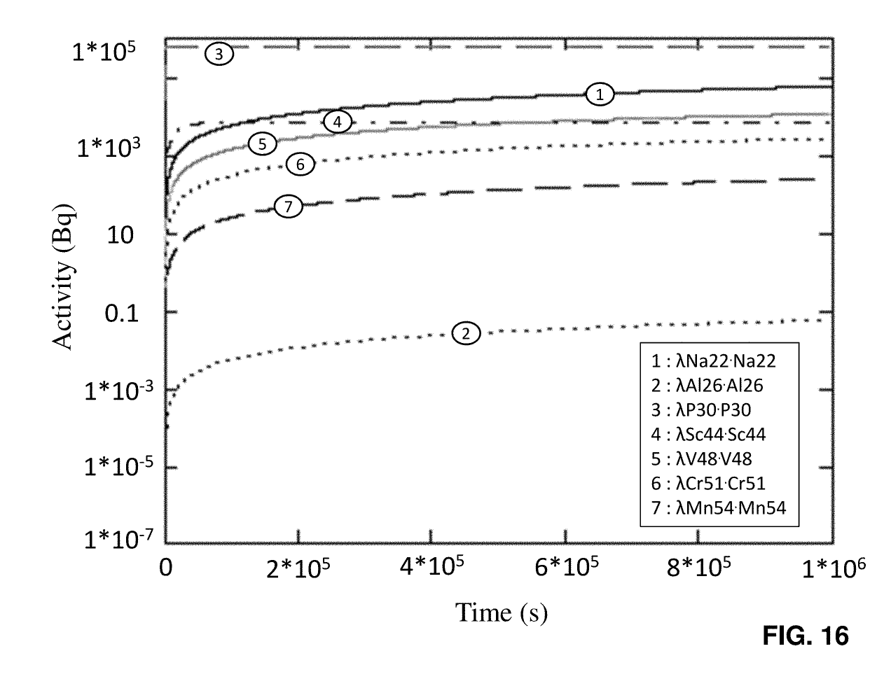

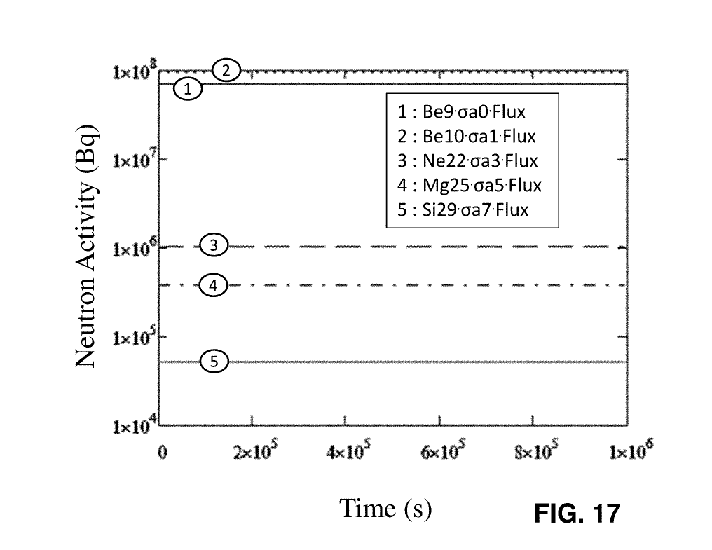

FIG. 14 is a plot, for several isotopes, of the number of initial atoms in calculations with an Am-241 source (1 Ci). FIG. 15 is a plot of the number of product atoms in the Am-241 (1 Ci, FIG. 15) calculations. FIG. 16 is a plot of activities of produced foils in the Am-241 (1 Ci, FIG. 15) calculations. FIG. 17 is a plot of neutron emission rate from target foils in the Am-241 (1 Ci, FIG. 15) calculations.

Similar calculations as those for which the results are shown in FIGS. 14-16 (1 Ci Am-241) were performed for a 0.1 Ci ²⁴¹Am source. This reduced the order of magnitude of product atoms (relative to FIG. 15) and activity of produced foils (relative to FIG. 16) by one. Similar calculations were also performed for the 10 mCi ²⁴¹Am source. This further reduced the order of magnitude of the product atoms and foil activities by one, demonstrating the results varied to scale with source activity. All cross sections and decays were kept the same.

Particular embodiments and features have been described with reference to the drawings. It is to be understood that these descriptions are not limited to any single embodiment or any particular set of features, and that similar embodiments and features may arise or modifications and additions may be made without departing from the scope of these descriptions and the spirit of the appended claims.

What is claimed is:

1. A switchable radiation source device comprising:
a primary source assembly that emits primary radiation; and
a target assembly in which, upon irradiation of the target assembly by the primary radiation, secondary radiation or radioactivity is produced;
wherein an alignment, proximity or exposure of the primary source assembly to the target assembly is adjustable to control irradiation of the target assembly by the primary radiation and thereby control the production of secondary radiation or radioactivity.

2. The switchable radiation source of claim 1, wherein:
the primary source assembly comprises at least one planar source tile;
the target assembly comprises at least one planar target tile; and
alignment of the source tile and target tile is adjustable by movement of the source tile or target tile.

3. The switchable radiation source of claim 1, wherein:
the primary source assembly comprises at least one planar source tile;
the target assembly comprises at least one planar target tile; and
proximity of the source tile and target tile is adjustable by movement of the source tile or target tile.

4. The switchable radiation source of claim 1, wherein:
the primary source assembly comprises a first planar array of separated multiple source tiles;
the target assembly comprises a second planar array of separated multiple target tiles; and
alignment of the source tiles and target tiles is adjustable by movement of at least one of the first planar array and second planar array.

5. The switchable radiation source of claim 4, wherein the first planar array is a rectangular array having rows in which interstitial blank cells are placed between the source tiles.

6. The switchable radiation source of claim 1, further comprising a shielding shell, wherein:
the primary source assembly comprises a shell that at least partially encloses the target assembly; and
the shielding shell is movable by rotation or translation between the primary source assembly and target assembly.

7. The switchable radiation source of claim 6, wherein the shielding shell is shaped as a spherical portion that at least partially encloses the target assembly, and the shielding shell is movable by relative rotation between the primary source assembly and target assembly.

8. The switchable radiation source of claim 7, wherein:
the primary source assembly comprises an outer hemispherical shell;
the shielding shell comprises an intermediate hemispherical shell between the outer hemispherical shell and the target assembly; and
the target assembly comprises an at least partially spherical core concentric with the outer hemispherical shell and intermediate hemispherical shell.

9. The switchable radiation source of claim 1, further comprising a shielding plate, wherein:
the primary source assembly has a planar shape;
the target assembly has a planar shape parallel to and spaced from the primary source; and
the shielding plate is movable between the primary source assembly and the target assembly to adjust exposure of the primary source assembly to the target assembly and thereby control the production of secondary radiation or radioactivity.

10. The switchable radiation source of claim 9, wherein the primary source assembly has a forward active side and a rear inactive side, and wherein the forward active side faces the target assembly.

11. The switchable radiation source of claim 1, wherein the primary source assembly emits primary radiation by natural radioactive decay.

12. The switchable radiation source device of claim 1, wherein the primary source assembly comprises an alpha particle emitter.

13. The switchable radiation source device of claim 12, wherein the secondary radiation or radioactivity causes ejection of one or more neutrons.

14. The switchable radiation source device of claim 13, wherein the target assembly comprises a stable isotope and irradiation of the target assembly by the primary radiation creates a compound nucleus and the one or more neutrons.

15. The switchable radiation source device of claim 1, wherein the target assembly comprises a circular arrangement of multiple target panels, and the primary source assembly comprises a source panel relative to which the circular arrangement of multiple target panels is rotatable.

16. The switchable radiation source device of claim 15, wherein the multiple target panels comprise different respective target materials.

17. The switchable radiation source device of claim 15, wherein the target assembly comprises an annular base ring upon which the multiple target panels are mounted in the circular arrangement.

18. The switchable radiation source device of claim 17, wherein the switchable radiation source device is operated by rotary movement of the annular base ring relative to the source panel to at least partially align a selected target panel with the source panel.

19. The switchable radiation source device of claim 16, wherein the source panel comprises an alpha-emitting radioactive isotope.

20. The switchable radiation source device of claim 19, wherein the secondary radiation or radioactivity causes ejection of one or more neutrons and the energy of the one or more neutrons varies according to the different respective target materials.
